(19) United States
(12) Patent Application Publication
(10) Pub. No.: US 2009/0313353 A1
(43) Pub. Date: Dec. 17, 2009

(54) COPYRIGHTED CONTENT DELIVERY OVER P2P FILE-SHARING NETWORKS

(75) Inventor: Xiaosong Lou, San Gabriel, CA (US)

Correspondence Address: MCDERMOTT WILL & EMERY LLP, 2049 CENTURY PARK EAST, 38th Floor, LOS ANGELES, CA, 90067-3208, US

(73) Assignee: UNIVERSITY OF SOUTHERN CALIFORNIA, Los Angeles, CA (US)

(21) Appl. No.: 12/251,344

(22) Filed: Oct. 14, 2008

Related U.S. Application Data
(60) Provisional application No. 60/980,123, filed on Oct. 15, 2007.

(51) Int. Cl. G06F 15/16; G06F 21/00

(52) U.S. Cl. 709/219; 726/26

(57) ABSTRACT

A copyright protection system for large scale content delivery over peer-to-peer P2P networks is disclosed. The system may integrate the complementary protections of a peer authorization protocol (PAP), selective content distribution and poisoning, and peer collusion detection. The system may include a transaction server computing system coupled to a P2P network and configured to enable users on the P2P network to conduct transactions for acquiring digital content to thereby become authorized clients for the digital content; and a plurality of distribution agent computing systems coupled to the central server and the P2P network, each distribution agent configured to store and distribute said digital content to said authorized clients distinguish authorized clients from unauthorized peers using a peer authorization protocol (PAP), selectively distribute poisoned versions of the digital content to unauthorized peers while distributing the digital content in a clean form to the authorized clients, cause a random plurality of the authorized clients to send download requests for a copyright protected file to other peers suspected of being unauthorized, receive, from one or more of the suspected other peers, clean copies of the file in response to the download requests; and identify the one or more suspected other peers as unauthorized peers.

### CROSS-REFERENCE TO RELATED APPLICATION(S)

This application is based upon and claims priority to U.S. Provisional Patent Application Ser. No. 60/980,123, entitled “Copyrighted Content Delivery Over P2P File-Sharing Networks,” filed Oct. 15, 2007, attorney docket number 28080-298, the entire content of which is incorporated herein by reference.

### GOVERNMENT'S INTEREST IN APPLICATION

This work was funded in part by NSF ITR Grant ACI-0325409. The government has certain rights in the invention.

### BACKGROUND

1. Field

This application relates to copyright protection of electronic information.

2. Description of Related Art

Traditional content delivery networks (CDNs) use a large number of surrogate content servers over many globally distributed WANs. The content distributors may need to replicate, or cache, contents on many servers. The bandwidth demand and resources needed to maintain these CDNs are very expensive.

Peer-to-Peer (P2P) file-sharing networks can significantly reduce the costs of large scale delivery of electronic content over the Internet and other networks, since many content servers may be eliminated and open networks are used. P2P networks may improve content availability, since any peer may serve as a content provider. In spite of these advantages, P2P networks have not been the subject of many commercial content-delivery applications. A major reason contributing to the possible underutilization of this resource relates to the traditional absence of adequate intellectual property protection accorded by this resource. In particular, a significant portion of content distributed over these networks may potentially violate copyright laws.

The main sources of illegal file sharing are peers who ignore copyright laws and collude with pirates, or peers attempting to download some content file without paying or authorization. The colluders are those paid or otherwise authorized peers who, without authorization, share the contents with pirates. Pirates and colluders coexist with the clients (legitimate peers).

Examples of such P2P content delivery systems include KaZaA, eMule, and BitTorrent, among others. These “home grown” systems are not supported by specialized Internet protocols. Unlike web server and content delivery networks (CDN), these systems do not require a central server. These systems are widely used for distributing free content such as open-source software and Linux operating systems. In addition, due to factors such as a relatively low content distribution cost and peer anonymity, these systems are also used for the illicit distribution of copyright-protected music and movies.

Various digital rights management (DRM) systems have been developed in an attempt to stifle the unauthorized distribution of copyrighted content. Implementing DRM in large-scale P2P networks, however, is too expensive to be realistic.

Another technique developed to curb Internet piracy is content poisoning. Content poisoning is the deliberate falsification of file content to those download attempts that are initiated from unpaid peers. The content poisoning technique is based on the assumption that the digital content is useful only if the content is received in its entirety. This is usually the case for many compressed files, CD-ROM images, MPEG-4 videos, and the like. Content poisoning is intended to be a deterrent to stop or discourage copyright abuses. The rationale behind the technique is that, if the clients spend time downloading what turn out to be falsified files, eventually frustration will lead them to stop the abusive use of P2P file-sharing services. Nevertheless, several universal “brute-force” poisoning efforts by the industry have met with considerable controversy and questionable success.

So-called “reputation systems” have been developed for various applications in P2P file-sharing networks, such as, for example, Eigentrust, PeerTrust, and PowerTrust. Reputation systems generally provide some facility to gauge the “trustworthiness” of a given peer. Additionally, gossip protocols were proposed for randomized communication and for global reputation aggregation in P2P networks.

Further, a mechanism is needed to properly identify a paid customer in P2P networks, versus an unpaid peer. In identifying paid customers, the content owner may be obligated not to disclose customer's identity information to third parties. In P2P file-sharing networks, this problem is complicated. First, to maintain the security of the information, only the content owner can verify the userID/password pair. Second, because the content is distributed via file sharing among peers, revealing a user's identity to other peers violates the privacy obligation. These two limitations impose further constraints on the ability to identify legitimate customers.

What is needed is a comprehensive solution for a copyright protection framework for implementation in P2P networks that, much like the P2P networks themselves, is independent of a specific architecture or network topology, does not rely on a content distribution network with a central server, and maintains anonymity where required.

### BRIEF SUMMARY

A copyright protection system for large scale content delivery over peer-to-peer P2P networks is disclosed. The system may integrate the complementary protections of peer authorization protocol (PAP), selective content distribution and poisoning, and peer collusion detection.

The system may include a transaction server computing system coupled to a P2P network and configured to enable users on the P2P network to conduct transactions for acquiring digital content to thereby become authorized clients for the digital content; and a plurality of distribution agent computing systems coupled to the central server and the P2P network, each distribution agent configured to store and distribute said digital content to said authorized clients distinguish authorized clients from unauthorized peers using a peer authorization protocol (PAP), selectively distribute poisoned versions of the digital content to unauthorized peers while distributing the digital content in a clean form to the authorized clients, cause a random plurality of the authorized clients to send download requests for a copyright protected file to other peers suspected of being unauthorized, receive, from one or more of the suspected other peers, clean copies of the file in response to the download requests; and identify the one or more suspected other peers as unauthorized peers.

These, as well as other objects, components, steps, features, benefits, and advantages, will now become clear from a review of the following detailed description of illustrative embodiments, the accompanying drawings, and the claims.

### BRIEF DESCRIPTION OF DRAWINGS

The drawings disclose illustrative embodiments. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it is intended to refer to the same or like components or steps.

FIG. 1 illustrates an example of a layered architecture of the P2P content distribution system with copyright protection.

FIG. 2 illustrates a conceptual diagram of an exemplary bootstrap agent observing an end-point address in a CP2P network according to an embodiment.

FIG. 3 illustrates a flow diagram of an exemplary handshaking process for a client to join a P2P network supported by one embodiment of the peer authorization protocol (PAP).

FIG. 4 illustrates a flow diagram of an exemplary procedure for responding to download requests by a peer.

FIG. 5 illustrates a conceptual diagram of an exemplary proactive poisoning mechanism in a P2P network.

FIG. 6 illustrates a conceptual diagram of an exemplary collusion detection process in a P2P network.

FIGS. 7(a)-(c) illustrate graphs showing quantitative analyses of poisoning effect in BitTorrent, Gnutella, and eMule P2P networks, respectively.

FIG. 8 illustrates a block diagram of an exemplary computing system on which the functionality of transaction server, private key generator, or distributed agents may be implemented.

### DETAILED DESCRIPTION OF ILLUSTRATIVE EMBODIMENTS

Illustrative embodiments are now discussed. Other embodiments may be used in addition or instead. Details that may be apparent or unnecessary may be omitted to save space or for a more effective presentation. Conversely, some embodiments may be practiced without all of the details that are disclosed.

The capability for such large-scale distribution means that the number of legal applications of P2P networks can increase, including in business services, e-commerce, distance learning, and other disciplines where intellectual rights are of primary concern.

Disclosed is a copyrighted P2P (“CP2P”) content distribution framework for copyright protection in P2P content delivery. According to one aspect, copyright protection is achieved in this system using one or more of three complementary techniques: (1) Authentication protocols to distinguish paid customers from unpaid peers; (2) selective content distribution and poisoning to help assure that paid customers will receive clean digital content, while unpaid peers will only receive poisoned copies; and (3) protocols for detection and avoidance of collusions between paid clients and pirates.

In another aspect, a PAP protocol uses IBS, which is a form of asymmetric cryptography. A communicating party in IBS only needs a private key, unlike in the well-known public key infrastructure (PKI) where a pair of public/private keys is needed. In essence, the communicating party's identity is its public key. IBS may be more suitable in terms of scalability for P2P environments where peer number is generally very large and where each peer would need to communicate with any other peer.

Some or all of the following parameters or notations may be used in this disclosure:

| Term, Symbol | Brief Definition |
|---|---|
| Access token, T | A short-life token for file access control |
| Time stamp, tₛ | Used in securing file index/query/requests |
| User address, p | User endpoint address observed by agent |
| File index, φ | Pointer to access the requested content file |
| Clean file size, f | Original file size in bytes without poisoning |
| Download file, d | Actual bytes downloaded, (d ≧ f) |
| Poisoning rate, δ | Probability of getting a poisoned chunk |
| Chunk number, m | Number of chunks in a single content file |
| Collusion rate, ε | Percentage of paid peers acting as colluders |
| Piracy rate, r | Percentage of pirates detected |
| Download times, | Expected times to download a clean file by a paid |
| T_{c} and Tₚ | client and a detected pirate, respectively |
| Tolerance, θ | Maximum download time tolerable by peers |
| Success rate, β | Probability of detecting a pirate |

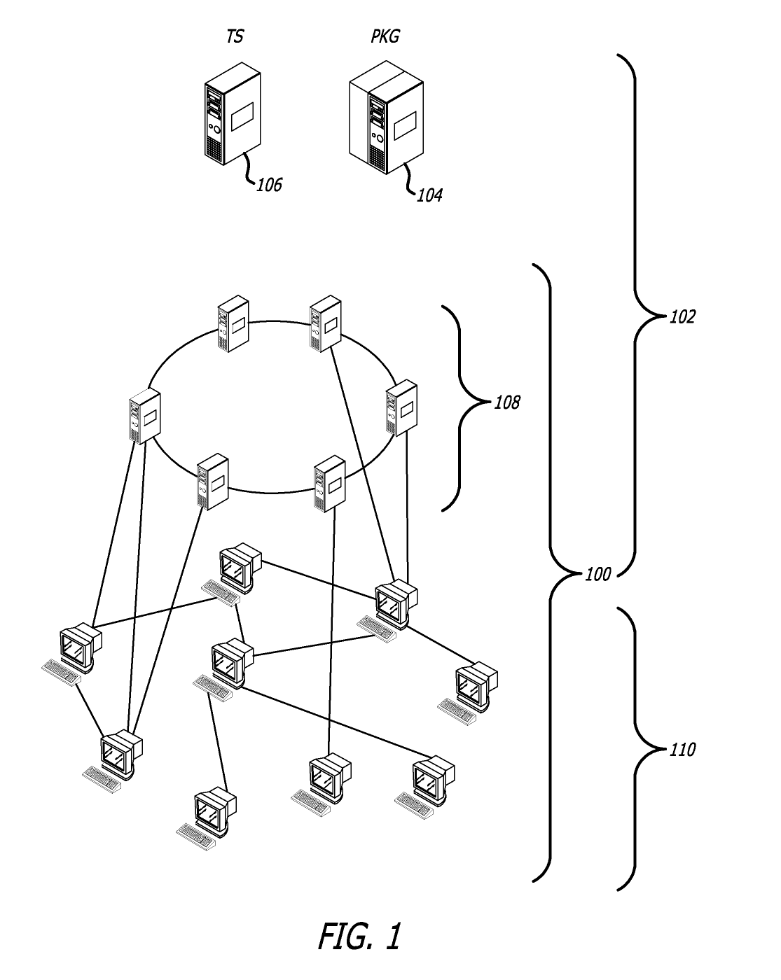

Referring now to FIG. 1, a layered architecture of the CP2P content distribution system is shown in accordance with an embodiment. The system may employ a three-layer design centered on the content owner/distributor. In a first layer resides transaction server 106, such as, for example a conventional web server. Transaction server 106 is responsible for conducting transactions related to the purchasing and billing of the digital content. The first layer may also include private key generator 104 for providing private keys to be used in the APA protocol. Transaction server 106 may reside on multiple computers including, in one embodiment, multiple distributed computers.

In a second layer resides a plurality of distribution agents 108. Distribution agents are trusted peers owned, controlled are operated by content owners (or their proxies) for file distribution. The distribution agents 108, together with the transaction server 106 and private key generator 104, may be set up by the content owner(s) 102. The primary function of a distribution agent 108 in this embodiment is to provide peer authentication, distribute digital content to paid customers and prevent unpaid peers from downloading the same content via content poisoning techniques.

In a third layer resides other peers 110, including both customers and unpaid peers. The second and third layers together may form a common P2P file sharing network 100. Network 100 may be built over a large number of peers.

In the CP2P system according to an embodiment, a customer uses two forms of communication to receive digital content. First, the customer logs on to the website or other network location to conduct a transaction to purchase the desired digital content. At the end of the transaction, the customer may receive an encrypted digital receipt containing information such as content title, customer ID, and the like. The customer also may receive the address of a bootstrap distribution agent as its first point of contact in the applicable P2P file-sharing network.

For example, to join the system, clients may submit requests for content to the transaction server 106. Private key generator (PKG) 104 may generate private keys with identity-based signatures (IBS) for securing communication among the peers. The PKG 104 has a similar role of a certificate authority (CA) in PKI services. In one embodiment, however, a difference lies in the fact that CA generates the public/private key pairs, while PKG only generates the private key.

In this embodiment, transaction server 106 and PKG 104 are only used initially when peers are joining the P2P network. With IBS, the communication between peers does not require explicit public key, because the identity of each party is used as the public key. File distribution and copyright protection may as such be completely distributed.

The number of peers sharing or requesting the same file at any point of time may be around hundreds or more. Depending on the variation of the swarm size, only a handful of distribution agents may be needed. For example, it may be sufficient to use 10 PC-based distribution agents 106 to handle a swarm size of 2,000 peers. These agents may authorize peers to download and prevent unpaid peers from getting the same contents.

Paid clients, colluders, and pirates are all mixed up without visible labels. The copyright-protection system in one aspect is designed to distinguish them automatically. Each client may be assigned with a bootstrap agent, selected from one of the distribution agents 106, as its entry point. In current P2P networks, a peer can self-assert its username without verification. In an embodiment, peer endpoint address (IP address+port number) may be used instead of username to identify a peer. In this embodiment, a peer is considered fully connected if it is reachable via a listening port on its host.

The endpoint address of the listening port may be used as a peer identity. For simplicity, it is assumed that each peer have a statistically configured listening port. Currently, most P2P users connect to the Internet via a home network. In such environments, statistically configuring the NAT device to forward incoming packets to a few P2P nodes is a norm. The constraint occurs when a large number of peers are behind a single NAT device.

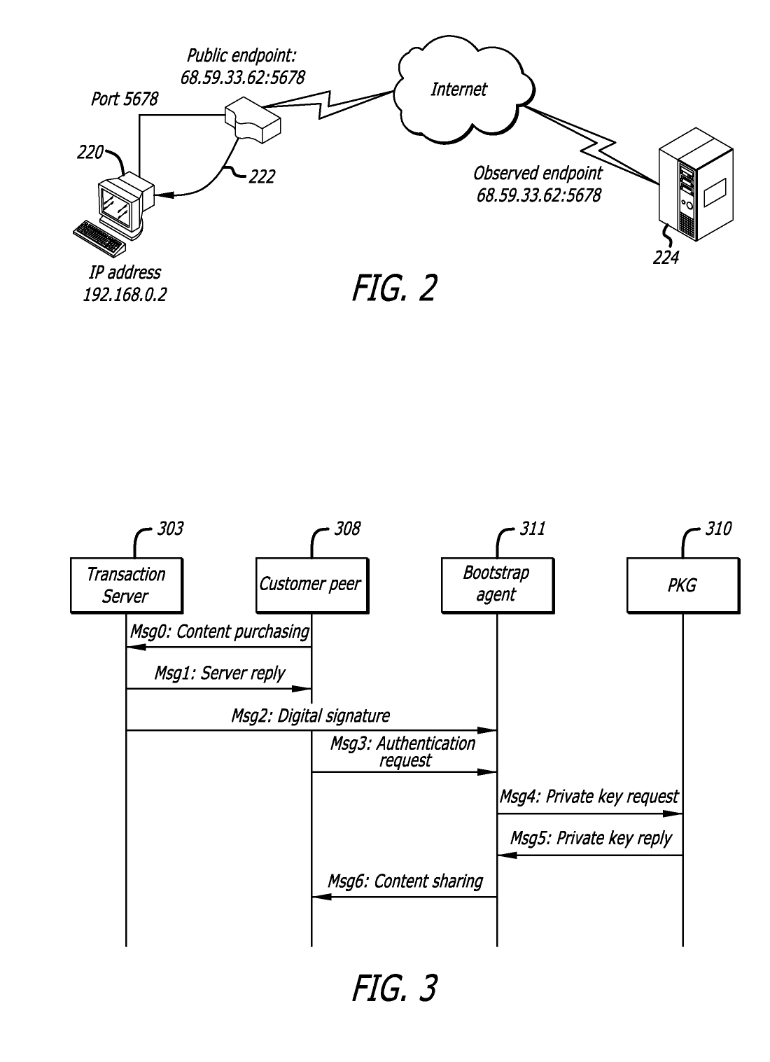

FIG. 2 is a conceptual diagram of a illustrative bootstrap agent observing an end-point address in a CP2P network according to an embodiment. A peer 220 may have IP address 192.168.0.2 leased from its local router 222. The peer 220 may be listening to port 5678 forward by the router 222 to the peer (i.e., to IP address 192.168.0.2). The router has public IP address 68.59.33.62. When communicating with the bootstrap agent 224, the peer 220 may announce its listening port number. The bootstrap agent 224 may, for example, call an Observe( ) subroutine, which verifies that the same peer 220 is indeed reachable via the claimed port, although its public IP address is actually 68.59.33.62. Hence the peer 220 is identified by 68.59.33.62:5678.

The detail of Observe( ) is as follows: when a peer 220 sends message to its bootstrap agent through outgoing port, the agent 224 may attach a random number (nonce) in the reply. The agent 224 may then send a message to the advertised listening port 68.59.33.62:5678, asking the peer 220 to send back the nonce. If the peer replies correctly, then its endpoint is verified.

In an embodiment, the endpoint address may be used as peer's public key. There is no need to encrypt the file body. This reduces the system overhead. Enabling peers behind NAT without a static listening port requires a hole-punching mechanism. The system uses the bootstrap agent to forward the incoming requests. The identities of all agents, except the bootstrap agent 224, may be hidden from clients. This stops a malicious blacklist or attack on the distribution agents.

The CP2P system anticipates the presence of both rule-abiding customers and potential unpaid users. To prevent copyright violations inside P2P file sharing network 100 while concurrently providing secure and exclusive file distribution to legitimate, paid customers, the system may perform, among other functions, one or more of the four functions enumerated in Table 1.

TABLE 1
Functionalities and Protocols for CP2P Content Distribution

| Function | Protocol Requirements |
|---|---|
| Secure file Indexing | File index format is modified to include |
| | token and IBS signature. |
| Peer Authorization Protocols | Entering peer sends digital receipt to |
| (PAP) | authenticate distribution agent and |
| | obtain an IBS based token. The token |
| | should be refreshed periodically. |
| Proactive Content Poisoning | The token and IBS signature check all |
| | download requests and responses |
| | and send clean or poisoned contents, |
| | accordingly. |
| Random Collusion Prevention | Distribution agents randomly recruit |
| | decoys to probe for colluders. |
| | Collusion reports are weighted against |
| | client trust rates. |

Proactive content poisoning with or without the other mechanisms may be performed inside P2P file sharing network 100 (e.g., layers 2 and 3 of CP2P) by the CP2P file sharing protocol. In an embodiment, the file sharing protocol of the CP2P is a modification to existing protocols such that the CP2P protocol is backward compatible with these existing protocols. In addition, the CP2P system may also be designed on top of an abstract layer of P2P file-sharing network 100, such that the system may be implemented in any of the existing popular P2P networks, such as BitTorrent, Gnutella, eMule, and the like, or on down-the-road P2P networks.

The customer may use P2P file-sharing software to download the desired content. Because the content owner has no control over the software used by a customer, it can be realistically expected that there will be deliberate attempts from both paid customers and hackers to distribute the content to unpaid peers. The CP2P system may provide techniques to detect and defend against such attacks.

### Peer Authentication

In general, in a P2P content distribution network, only the content owner can verify the userID/password pair; peers cannot check each other's identity. Revealing a user's identity to other peers violates his or her privacy. A PAP protocol is disclosed herein to solve this problem.

FIG. 3 illustrates a handshaking process for a client to join a P2P network supported by one embodiment of the peer authorization protocol (PAP). For a peer 308 to join the network, it first logins to a transaction server 303 to purchase the content. After transaction, the customer 308 receives a digital receipt which may contain the content title, client ID, and the like. This receipt may be encrypted such that only content owner and distribution agent can decrypt.

In the illustrated embodiment, the customer 308 receives the address of the bootstrap agent 311 as its point of contact. The joining client 308 authenticates with the bootstrap agent 311 using the digital receipt. The session key assigned by the transaction server 303 secures their communication. Since the bootstrap agent 311 is setup by the content owner in this example, the bootstrap agent 311 may decrypt the receipt and authenticate its identity. The bootstrap agent 311 may request a private key from PKG 310 and constructs an authorization token, accordingly.

In the example shown, let k be the private key of content owner and id be the identity of the content owner. Eₖ(msg) is used to denote the encryption of message with key k. The Sₖ(msg) denotes a digital signature of plaintext msg with key k. The client is identified by userID and the file by fileID.

Each legitimate peer in this example has a valid token. The token according to one embodiment is only valid for a short time so that a peer needs to refresh the token periodically. To ensure that peers not to share the content with pirates, the trusted P2P network may modify the file-index format to include a token and IBS peer signature. Peers may use this secured file index in inquiries and download requests. In one embodiment, seven messages are specified below for protected peer joining process as illustrated in FIG. 3:

Msg0: Content purchase request

Msg 1: BootstrapAgentAddress, Eₖ (digital_receipt, BootstrapAgent_session_key)

Msg2: Adding digital signature Eₖ (digital_receipt)

Msg3: Authentication request with userID, fileID, Eₖ (digital_receipt)

Msg4: Private key request with privateKeyRequest (observed peer address)

Msg5: PKG replies with privatekey

Msg6: Assign the authentication token to the client

Peers may identify the pirates or unauthorized peers by checking the validity of extra signatures in file indices. The trusted P2P applies this protection to share clean contents exclusively among the peers, and use content poisoning techniques against the pirates. Tokens are time-stamped and need to be refreshed periodically. Colluders detected by the disclosed system cannot receive new token after its current token expires.

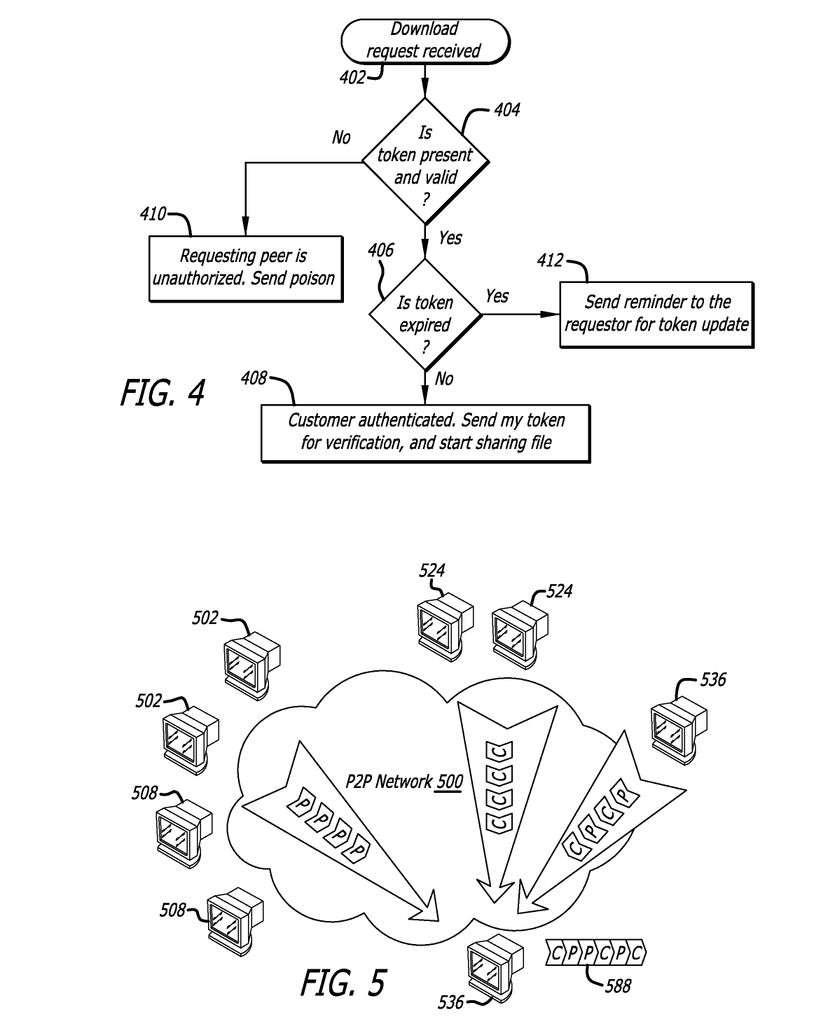

FIG. 4 illustrates a procedure for each peer when responding to download requests. A download request is received at a peer (402). A peer first identifies the presence of a valid token (404). If the request does not contain a valid token, the requester is thereupon deemed unauthorized and the peer is designated to send poisoned content (410). If the token is valid but has expired, then the peer may send a reminder to the requester to obtain a new token (412). If the token is valid and unexpired, the customer is considered authenticated. The peer sends its token for verification and begins to share the file (408). When a peer requests a file, the peer also checks the response to the file download request for a valid token. Without a token, the content provider could have been poisoned.

Below is specified in more detail aspects wherein (1) IBS may be applied to secure file indexing, (2) tokens are generated, and (3) file access is authorized via PAP.

### Secure File Indexing

In a P2P file-sharing network, a file index may be used to map a fileID to a peer endpoint address. When a peer requests to download a file, it may first query the indices that match a given fileID. Then the requester downloads from selected peers pointed by the indices. To detect pirates from paid clients, in an aspect, the file index is modified to include three interlocking components: an authorization token, a timestamp, and a peer signature.

Each legitimate client may have a valid token assigned by its bootstrap agent. The timestamp indicates the time when token expires. Thus the peer needs to refresh the token periodically. This short-lived token is designed for protecting copyright against colluders. The cost at each distribution agent to refresh the client tokens is rather limited, as shown via experiments. The peer signature is signed with the private key generated by PKG. This signature proves the authenticity of a peer.

Download requests make explicit references to file indices. The combined effects of the three extra fields ensure that all references to the file indices are secured. Peers identify the pirates by checking the validity of the token and the signature in a file index. These features secure the P2P network operations to safeguard the sharing of clean contents among the paid clients.

File-Level Token Generation

First, both the transaction server and the PKG are fully trusted. Their public keys are generally known to all peers. The PAP protocol may comprise two parts: token generation and authorization verification. When a peer joins the P2P network, it may first send authorization request to the bootstrap agent. All messages between a peer and its bootstrap agent may be encrypted using the session key assigned by the transaction server at purchase time.

The authorization token may be generated by Algorithm 1 specified below. A token is a digital signature of a 3-tuple: {peer endpoint, file ID, timestamp} signed by the private key of the content owner. Since bootstrap agent has a copy of the digital receipt sent by transaction server, verifying the receipt may thus be done locally. The Decrypt(Receipt) function decrypts the digital receipt to identify the file λ. The Observe(requestor) returns with the endpoint address p. The OwnerSign (λ, p, tₛ) function returns with a token.

Upon receiving a private key, the bootstrap agent digitally signs the fileID, endpoint address, and timestamp to create the token. The reply message contains a 4-tuple: {endpoint address, peerprivate key, timestamp, token}. The reply message from bootstrap agent is encrypted using the assigned session key.

Algorithm 1: Token Generation

| Input: Digital Receipt | |
|---|---|
| Output: Encrypted authorization token T | |
| Procedures: | |
| 01: | if Receipt is invalid , |

| | |
|---|---|
| 02: | deny the request; |

| | |
|---|---|
| 03: | else |

| | |
|---|---|
| 04: | λ= Decrypt(Receipt); |

// λ is file identifier decrypted from receipt //

| | |
|---|---|
| 05: | p = Observe(requestor); |

// p is endpoint address as peer identity//

| | |
|---|---|
| 06: | k = PrivateKeyRequest (p); |

// Request a private key for user at p //

| | |
|---|---|
| 07: | Token T = OwnerSign(f, p, tₛ) |

// Sign the token T to access file f //

| | |
|---|---|
| 08: | Reply = { k, p, tₛ, T} |

// Reply with key, endpoint address,

timestamp, and the token //

| | |
|---|---|
| 09: | SendtoRequestor { Encrypt(Reply) } |

// Encrypt reply with the session key //

| | |
|---|---|
| 10: | end if |

Peer Authorization Protocol

A more detailed example of a PAP protocol in accordance with an embodiment is specified below. A client must verify the download privilege of a requesting peer before clean file chunks are shared with the requester. If the requester fails to present proper credentials, the client must send poisoned chunks.

In PAP, a download request may apply a token T, file index φ, timestamp tₛ and the peer signature S. If any of the fields are missing, the download is stopped. A download client must have a valid token T and signature S. Two pieces of critical information are needed: public key K of PKG and the peer endpoint address p.

Algorithm 2 verifies both token T and signature S. File index φ(λ, p) contains the peer endpoint address p and the fileID A. Token T also contains the file index information and Vindicating the expiration time of the token. The Parse(input) extracts timestamp tₛ, token T, signature S, and index φ from an download request. The function Match (T, tₛ, K) checks the token T against public key K. Similarly, Match(S, p) grants access if S matches with p.

Algorithm 2: Peer Authorization Protocol

Input: T = token, tₛ = timestamp, S = peer signature,

and φ(λ, p) = file index for file λ at endpoint p

| Output: Peer authorization status | |
|---|---|
| True: authorization granted | |
| False: authorization denied | |
| Procedures: | |
| 01: | Parse (input) = { T, tₛ, S, φ(λ, p) } |
| | // Check all credentials from a input request // |
| 02: | p = Observe(requestor); |

// detect peer endpoint address p //

| 03: | if { Match (S, p) fails }, |
|---|---|
| //Fake endpoint address p detected // | |
| return false; | |
| 04: | endif |
| 05: | if { Match(T, tₛ, K) fails }, |

return false;
// Invalid or expired token detected //

| | |
|---|---|
| 06: | endif |
| 07: | return true; |

When a client downloads a tile, it needs to authorize the peer to share the file. Otherwise, downloading from a pirate may be poisoned, as shown in FIG. 4. When responding queries from honest peers, a client adopts a slightly reduced version of Algorithm 2: Because the inquiry is sent directly to endpoint p, the Observe( ) procedure is no longer required.

In contrast to a security-via-obscurity scheme, the PAP protocol is designed to be completely open.

Peer endpoint address is forgery proof collusive piracy is achievable, only if the pirate manages to communicate with other peers. IP spoofing can change pirate's endpoint address, resulting in pirate not to receive any response. Therefore, spoofing endpoint address during download is useless to a pirate. A pirate can intercept the token sent to a client, and masquerade its own endpoint address to match with the token. However, using the Observe( ) subroutine illustrated in FIG. 2, other clients will notice the masqueraded peer identity and fail its endpoint verification.

Authorization tokens cannot be shared by peers: A token is generated after the verification of a digital receipt. This is used to authorize a client to download the content. It is designed to be a digital signature of a 3-tuple: {fileID, endpoint address, timestamp}. Multiple peers cannot share this 3-tuple because each peer has a different endpoint address. Sharing the same token on different endpoint addresses will result in signature mismatch. This is applied to stop a pirate from using a stolen token.

Pirates cannot poison legitimate clients: The system modifies file index format to include tokens and signatures. When downloading from other peers, a client checks the file index for valid signatures. It only downloads file chunks from other legitimate clients that publish some valid file indices. Therefore, even if a pirate attempts to poison other peers, no legitimate client will use it as a download source.

Stolen private keys are useless to pirates: A pirate may hack into a peer's host to obtain its private keys. A colluder may even share these secrets with a pirate. However, sharing or stealing private keys does not help the pirate at all, because of the use IBS endpoint address as public key. Since other clients use Observe( ) subroutine to obtain peer endpoint address, stolen private keys can never be useful.

### Selective Content Distribution/Poisoninq

Content distribution is referred to herein as the sharing of clean, uncorrupted content among distribution agents and customers. Content poisoning refers to the deliberate falsification of digital content to those download attempts that are initiated from unpaid peers. Content poisoning exploits the limited patience of the targeted user. Many P2P file-sharing programs use some sort of built-in content verification functions in the form of file chunking protocols or different hash schemes to ensure the integrity of file contents. Corrupted content can be detected via hash mismatch. Depending on the hashing schemes used, part or all of a file may need to be re-downloaded. Where such download attempts fail multiple times, the user may become impatient enough to give up.

As shown in table 2, at least three distinct hash schemes are used in common P2P file-sharing networks, although additional or future such schemes may exist and are intended to fall within the scope of the present disclosure. BitTorrent clients acquire a clean set of file chunk hashes prior to download. In basic Gnutella protocol, a hash mechanism is not required. eMule clients exchange file chunk hashes during the P2P download.

In the CP2P system, every distribution agent and customer may act as a decoy toward unpaid peers. Let S be the actual file size and D be the total number of bytes downloaded. The poisoning effect is defined by:

Poisoning Effect=1−S/D (1)

Poisoning effect isolates the download effort wasted due to the existence of decoys that are providing poisoned chunks of content. Its value represents the portion of downloaded bytes that are wasted due to the existence of decoys in a P2P file sharing system. For example, in an ideal P2P file-sharing system where no decoy was present, then S=D. This means that the client received exactly the same amount of bytes as the actual size of the file. In this instance, the poisoning effect is zero. Conversely, if the download size D becomes extremely large relative to file size S, then the poisoning effect approaches 100%, meaning most download requests failed. Different hashing schemes may have a direct impact on the poisoning effects.

TABLE 2
Hashing Schemes in Three Exemplary P2P Networks

| P2P Network | Hash Distribution | Poisoning Detection |
|---|---|---|
| BitTorrent | Hash tree in index file | Detectable at |
| | outside of P2P network | chunk level |
| Gnutella | Not specified | Detectable after |
| | | download entire |
| | | file |
| eMule | FileID generated from | Detectable only if |
| | chunk hashes; peers | part hashset is |
| | exchange part hashset | not poisoned |

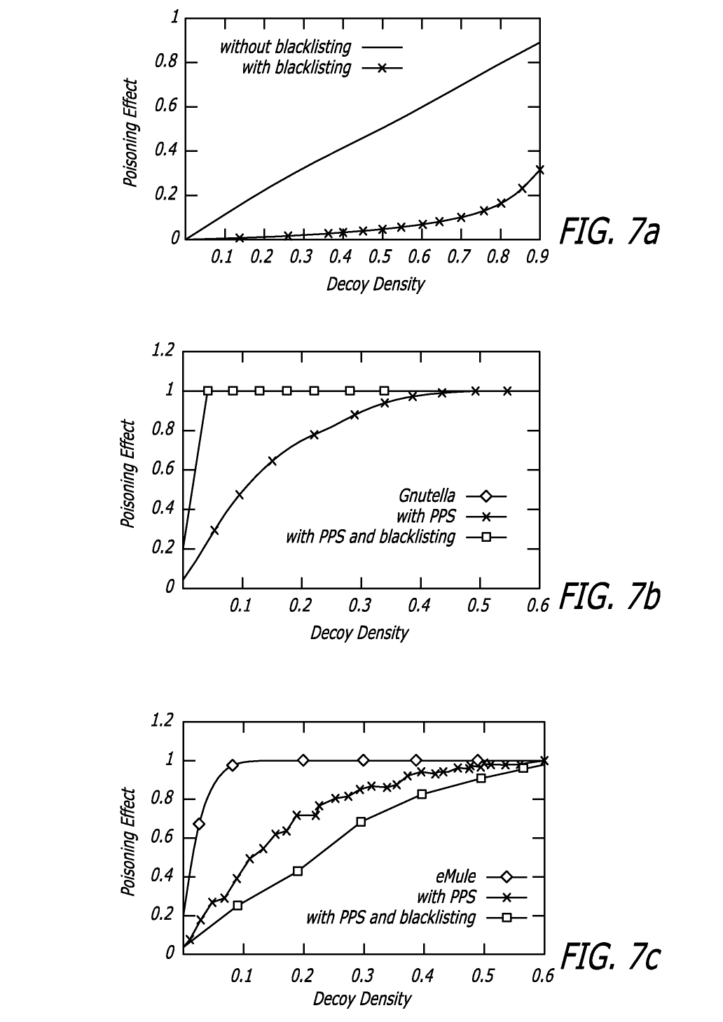

FIGS. 7(a)-(c) show graphs of poisoning effect versus decoy density of the three P2P file-sharing protocols of Table 2. The graphs show results of experiments on files containing 1000 chunks. A 1000-chunk file is equivalent to 64˜2000 MB in BitTorrent, or 180 MB in eMule. The poisoning effect is directly related to file chunk members, not the file sizes.

Throughout the experiments, downloads of clean copies of each file were attempted 100 times, and an average poisoning effect was reported. Decoy density is referred to herein as the percentage of decoys among all peers. Two commonly used techniques against content poisoning are also evaluated. First, many P2P clients prefer to select the current peer as the provider for the next file chunk, if the next file chunk is available on that peer. This strategy is referred to herein as preferred peer selection (PPS).

Second, some P2P file-sharing client software has already included a rudimentary subset of reputation system functions called blacklisting. Using a manually configured blacklist, a client can identify untrusted peers so that it will not be included in peer selection. However, such a system is not perfect; the user may not be able to blacklist all decoys, and in some cases a legitimate common provider may also be blacklisted.

On one hand, these quantities demonstrate that by making distribution agents and customer peers act as decoys in the P2P network, the content owner can effectively elevate poisoning effect of unpaid peers to such a high level that almost all the bytes downloaded are poisoned. On the other hand, the CP2P system may help ensure that a rule-abiding customer will not be poisoned. The significant discrepancy between the download performance of a customer and an unpaid peer may further discourage unpaid peers from attempting unauthorized down loads.

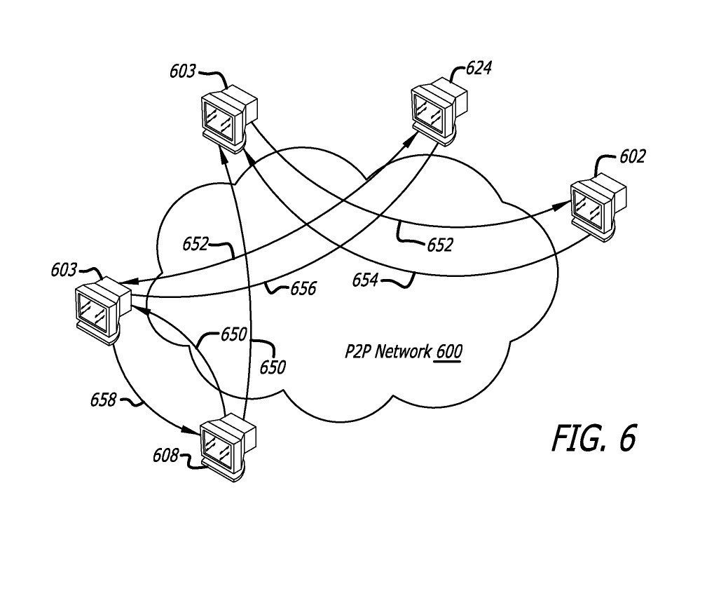

FIGS. 5 and 6 illustrate the proactive content poisoning mechanisms built in the P2P network 500 according to a further aspect. In FIG. 5, if a pirate 536 sends a download request to a distribution agent 508 or a client 502, then by protocol definition it will receive poisoned file chunks P. If the download request was sent to a colluder 524, then it may receive clean file chunks C. If a pirate 536 shares the file chunks with another pirate 536, then it could potentially spread the poison, as shown by the assembled stream 588.

Therefore, in another aspect, poisoned chunks are proactively sent to pirates, rather than simply denying their requests. Otherwise, even if all clients deny pirate's requests, the pirate still can assemble a clean copy from those colluders who have responded with clean chunks. With the poisoning technique as described herein, the limited poison detection capability of P2P networks may be exploited to force a pirate to discard the clean chunks downloaded with the poisoned chunks. The rationale behind such poisoning is that if a pirate keeps downloading corrupted file, the pirates will eventually give up the attempt out of frustration.

### Collusion Detection

Although the CP2P system is designed to tolerate the presence of colluders in the network, it can be shown that reducing number of colluders improves system performance. Therefore, a reputation-based colluder detection mechanism is introduced in accordance with another embodiment.

Traditionally, gossip protocol and power nodes played a crucial role in speeding up the reputation aggregation process in a P2P network. Randomized gossiping can reach consensus among all peers in a distributed manner. This approach exploits massive concurrency among millions of active nodes in a very large P2P network. The following embodiment is a simplified GossipTrust system to identify colluders in this paper.

The idea is to associate each {peer, file} pair with a collusion rate. The “0” rate means that the peer was never reported as a colluder. Otherwise, the peer is getting a collusion report of “1”, meaning it has shared clean content with illegal download requesters. This collusion rate is accumulative like the way e-Bay collects peer's reputation scores.

Distribution agents randomly recruit clients, called decoys, to send illegal download requests to suspected peers. A decoy is a peer that shares poisoned content. If an illegal request is returned with a clean file chunk, the decoy reports the collusion event. Since the decoy is randomly chosen, there exists a risk that the report is not trustworthy either by error or by cheating.

FIG. 6 illustrates the collusion detection process in exemplary P2P network 600. Distribution agent 608 recruits client decoys 603 and causes them to send illegal requests 652 to suspected peers 602. One suspected peer 602 sends back a first client decoy 603 poisoned chunks of content (654), while another suspected peer 602 sends back a second client decoy 603 clean chunks of content (656). It is thus determined that one suspected peer 603 returning the message with the clean content (656) is a colluder. The appropriate client decoy may thereupon report the colluder to distribution agent 608.

Thus a reputation system is used to screen the peers in another aspect. To choose honest decoys, a lightweight reputation system is disclosed in one embodiment. Consider a P2P network with n paid clients. A collusion vector C={Cᵢ} is defined, where 0≦cᵢ≦φ is the collusion rate of peer i. The collusion threshold φ is used to bar detected colluders from getting new tokens.

When a current token expires, the colluder is labeled as a pirate with denied access to the file.

A trust vector T={tᵢ}, where tᵢ=1−cᵢ/φ is defined for all 1≦i≦n. When a decoy i probes a peer j for collusion, it sends j an illegal request and send report rᵢⱼ to the agent. The condition rᵢⱼ=1 when j replies with a clean content. The collusion rate for peer j is computed by the following expression:

cⱼ=min{cⱼ+tᵢ×rᵢⱼ,φ} for all 1≦i,j≦n (2)

Peer i may be identified as a colluder, when its collusion rate exceeds the threshold, i.e. cᵢ≧φ. With this reputation system, a distribution agent weighs each decoy' report against its own trust score to determine the trustworthiness of the reported collusion event. Such a design helps ensure that a pirate will not be selected as a probing decoy.

Consider a case when the collusion threshold is set with φ=2.5. Consider an honest peer i with an initial collusion rate cᵢ=0 and thus a complete trust tᵢ=1 initially. A suspected client j has collusion rate cᵢ=1.6. Peer i is recruited to probe j, and i reports with rᵢⱼ=1. Peer j may be identified as a colluder since cⱼ=Min [1.6+1×1, 2.5]=2.5. This way, only high-reputation clients are hired as probing decoys. Thus more credibility is given to ensure the accuracy of colluder detection.

The disclosed CP2P content distribution system supports either structured or unstructured P2P networks.

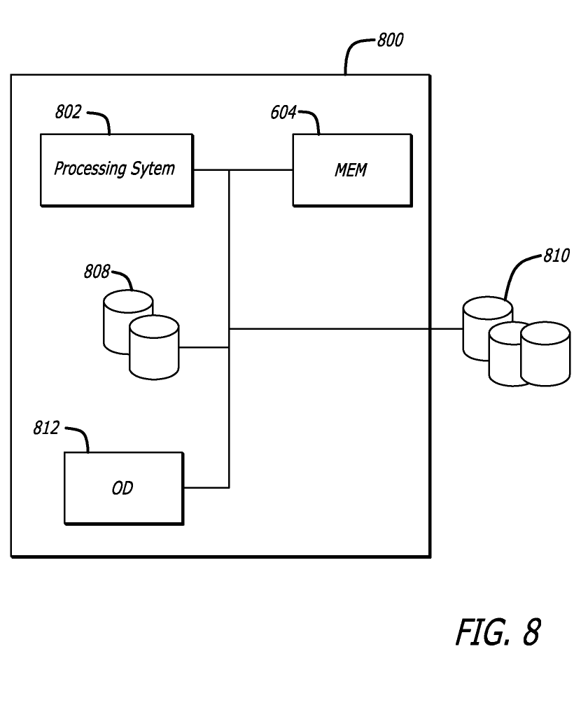

The transaction server 106, private key generator 104, and distribution agents 108 may be implemented in hardware or software, and are typically implemented on a computing machine with a processing system. FIG. 8 illustrates a block diagram of an exemplary computing system 800 on which the functionality of transaction server, private key generator, or distributed agents may be implemented. Computing system 800 includes processing system 802 coupled to memory 804, which may include RAM, ROM or another type of high speed memory, as well as internal storage drive 808 (such as a hard disk drive) and internal optical drive 812. In one embodiment, an external storage drive 810 may be used. For purpose of this disclosure, a “computing system” may in some instances refer to more than one physical computer. Further, in some instances, the physical computers comprising the computing system may be distributed in more than one location.

In general, the processing system 802 may be implemented using hardware, software, or a combination of both. By way of example, a processing system may be implemented with one or more integrated circuits (IC). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the general purpose processor may be any conventional processor, controller, microcontroller, or state machine. A processing system may also be implemented as a combination of computing devices, e.g., a combination of a DSP and a microprocessor, a plurality of microprocessors, one or more microprocessors in conjunction with a DSP core, or any other such configuration.

In one embodiment, the functionality of private key generator 104 may be included with that of transaction server 106. The functionality of private key generator 104, transaction server 106, and distribution agents 108 may each be implemented in any known computer language, such as Java, C, C++, Visual Basic, Assembler, Perl, etc.

The various components that have been discussed may be made from combinations of hardware and/or software, including operating systems and software application programs that are configured to implement the various functions that have been ascribed to these components above and in the claims below. The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

The phrase “means for” when used in a claim embraces the corresponding structures and materials that have been described and their equivalents. Similarly, the phrase “step for” when used in a claim embraces the corresponding acts that have been described and their equivalents. The absence of these phrases means that the claim is not limited to any of the corresponding structures, materials, or acts or to their equivalents.

Nothing that has been stated or illustrated is intended to cause a dedication of any component, step, feature, object, benefit, advantage, or equivalent to the public, regardless of whether it is recited in the claims.

In short, the scope of protection is limited solely by the claims that now follow. That scope is intended to be as broad as is reasonably consistent with the language that is used in the claims and to encompass all structural and functional equivalents.

I claim:

1. A system for protecting copyrighted digital content in a peer-to-peer (P2P) file sharing network, comprising
a transaction server computing system coupled to a P2P network and configured to enable users operating client computer systems on said P2P network to conduct transactions for acquiring digital content to thereby become authorized clients for said digital content; and
a plurality of distribution agent computing systems coupled to said central server and said P2P network, each distribution agent configured to:
distribute said digital content to said authorized clients; and
cause a random plurality of clients from among said authorized clients to send download requests for one or more copyright protected files to peers on said P2P network suspected of being unauthorized, to receive, from one or more of said suspected other peers, clean copies of said one or more files in response to said download requests, and to identify said one or more suspected other peers as unauthorized peers.
